(19) United States
(12) Patent Application Publication
(10) Pub. No.: US 2018/0311521 A1
(43) Pub. Date: Nov. 1, 2018

(54) METHOD AND DEVICE FOR HANDLING A HOSE SUPPLY

(71) Applicant: TACBAG Verwaltungs GBR, Mittelbrunn (DE)

(72) Inventor: Aron Fabian GEISEL, Schwalbach (DE)

(73) Assignee: TACBAC VERWALTUNGS GBR, Mittelbrunn (DE)

(21) Appl. No.: 15/772,481

(22) PCT Filed: Oct. 21, 2016
(86) PCT No.: PCT/EP2016/075447

§ 371 Date: Apr. 30, 2018

(30) Foreign Application Priority Data
Oct. 30, 2015 (DE) 10 2015 118 638.1

(51) Int. Cl. A62C 33/04; B65H 49/20; B65H 49/32; B65H 75/44

(52) U.S. Cl. CPC A62C 33/04; B65H 49/205; B65H 2701/33; B65H 75/4471; B65H 49/322

(57) ABSTRACT

Disclosed is a method for extinguishing a fire, comprising the following steps: a dimensionally stable hose and a reel comprising a central water connection that is rotatable relative to the reel are provided, the hose being wound on the reel; the dimensionally stable hose is designed in such a way as to have a second connection; furthermore, a transport device is provided in which the reel is rotatably mounted in order for the hose to be unwound; the hose is connected to the water supply conduit; the hose is unwound from the reel only by the length required to reach and extinguish the fire. The disclosed method dispenses with the time-consuming installing of hoses in bays and eliminates the associated risk of tripping over the hose. In the disclosed method, the wound dimensionally stable hose forms the hose supply. Moreover, the system can be filled with water and pressurized without any preparation at any time. The hose supply can remain in the bag. Also disclosed is a corresponding device, which can additionally be used as a rescue device.

### FIELD OF THE INVENTION

The invention relates to a method for handling a hose supply when extinguishing a fire, more precisely a house fire or a fire in a multi-storey building or another fire not directly accessible from a fire engine or another water source, and to a device for the safe and organised guided handling of the hose supply (hose management) during the firefighting process.

### PRIOR ART

The laying of hose lines on firefighting jobs and in particular the provision of hose supplies in buildings is often very difficult. In accordance with the current prior art, there are many different methods and approaches used by fire departments for forming hose lines and supplies in front of burning apartments, however these are usually relatively time-consuming, which in turn often leads to compromises in hose management. In such situations however, correct hose management is key for rapid and safe operational success.

Hitherto, hose lines have been laid by means of rolls of flat-rolled hose or by means of hose carrying baskets. When laying hose lines using rolls of flat-rolled hose, the hoses must first be rolled out outside the building, connected to one another, and then laid by hand as far as the incident location. At the incident location, the hose supply must also be formed manually so as to be able to advance into the smoke-filled danger zone.

The situation is similar when laying the hose line by means of hose carrying baskets. Although the laying of the hose line as far as the incident location is much simpler than with rolls of flat-rolled hose since, once the hose carrying basket has been connected to a fixed point (for example manifold) and carried away, the hose practically unrolls on its own from the hose carrying basket and lays itself, on arrival at the incident location, however, the hose firstly has to be removed from the hose carrying basket by hand and laid correctly in order to form hose supplies. Due to the design of the hose carrying basket, the carry frame is very unstable as the hose line is pulled out, whereby the simultaneous removal and laying of the hose line can only with difficulty be performed by one person.

As an alternative to hose carrying baskets, a range of devices are known, in which hoses wound onto a reel can be unwound from the reel as they are carried. Examples of this can be found in documents AT 36548, DE 867 954 and U.S. Pat. No. 3,722,823. A particular disadvantage here is that the hoses have to be fully unrolled before they can actually be used. The hose supply still has to be formed manually.

In all of these variants the hose line is laid pressure-free, i.e. the hose line is not yet filled with water. If the hose lines are then filled with water and placed under pressure, the hose often whips around as a result—kinks can thus form in the hose supply or, in the worst case scenario, a firefighter could be injured. In order to counteract this, the water is usually supplied only gently and cautiously, thus resulting in a loss of precious time.

Before the firefighters can ultimately advance into the burning apartment, due to pressure surges, the hose supply has to be checked a second time and corrected if necessary. If the hose supply is not correctly laid, it is only possible to a limited extent, or is completely impossible, to pull the hose line along, on account of the high friction.

Furthermore, due to their design, hose couplings frequently become stuck at corners, which also makes it impossible to pull the hose line along. For the advancing team of firefighters, this means that the fire fighting operation itself or, in the worst case scenario, the search for people has to be abandoned. The team firstly has to retreat in order to release the hose coupling so that the hose line can be pulled along again.

In addition, a hose supply that for example has been laid in a stairwell constitutes a trip hazard. Individuals, or members of the fire brigade who have to pass through the smoke-filled area do not notice the hose supply, which can result in injury (caused i.a. by falling).

### Problem

The problem addressed by the invention is that of providing a method and a device which improve firefighting operations, therein in particular hose management.

### Solution

This problem is solved by the subjects of the independent claims. Advantageous further developments of the subjects of the independent claims are characterised in the dependent claims. The wording of all the claims is hereby incorporated in the content of this description by reference.

Individual method steps will be described in greater detail hereinafter. The steps do not necessarily have to be performed in the specified order, and the method to be described can also comprise further steps which are not mentioned.

In order to solve the problem, a method for handling a hose supply when extinguishing a fire is proposed, in which method a water supply line is firstly laid with the aid of at least one hose or is made available by means of a fire engine. Typically, a main supply line is firstly laid from the hydrant or from the fire engine and ends in a manifold. There, a further supply line is connected which reaches as far as the storey on which the incident has occurred or just before the location of the fire. Hoses which are not dimensionally stable are usually used for these lines. In the case of fires that have greater accessibility, the lines alternatively can be connected directly to the fire engine.

The following steps are now performed for the proposed method: A preferably dimensionally stable hose and a reel comprising a central water connection that is rotatable relative to the reel and that ensures a fluid connection to the hose wound on the reel are provided. The hose is formed in such a way that it has a second connection at its end not connected to the central water connection. A transport device for the reel is also provided. The reel is rotatably mounted in the transport device for unwinding of the hose. The transport device is fixed in the area of the end of the water supply line, for example to a handrail in a stairwell. The water supply line is connected to the central water connection of the reel (for example via a short hose). The hose is unwound from the reel, as attack hose, only by the length required to reach the fire, and the fire is lastly extinguished. The wound part of the attack hose forms the hose supply.

In this method there is no longer a need to form additional hose supplies, whereby the time-consuming laying of hose lines in bays and the resultant trip hazard are eliminated. By means of the system being self-contained, hose couplings are also prevented from becoming stuck or caught at corners. In addition, the system can be filled with water and pressurised at any time and without preparation. The hose supply may here remain in the transport device. Pressure surges also do not compromise the hose supply, and kink-free guidance of the hose line is always ensured. It is here additionally advantageous that the advancing firefighter has to carry a particularly low amount of weight.

In a variant of the proposed method, the water supply line is connected to the second connection of the dimensionally stable hose. Furthermore, an attack hose is connected to the central water connection of the reel. For example, a short hose that is mounted externally and that is connected to the central water connection of the reel is used as an attack hose. This hose may or may not be dimensionally stable, wherein the dimensionally stable embodiment is preferred, and is between 1 and 3 m long, preferably between 1.5 and 2.5 m long, particularly preferably 2 m long. The length of the attack hose is selected here in such a way that it can be handled by one person and the risk of the attack hose buckling or kinking is very small. This attack hose is guided to the fire, wherein the transport device is brought along with the reel with the dimensionally stable hose. Here, the dimensionally stable hose is unwound from the reel only by the length required to reach the fire. This approach enables particularly good handling and control of the attack hose and of the hose supply.

The hose is preferably dimensionally stable, and a bag is provided as transport device, which bag has a form adapted to the form of the reel, more than 50% of the surface of said bag consisting of flexible material and said bag having at least one handle and/or strap, by means of which said bag can be carried.

With appropriate design of the bag, this method has the additional advantage that the bag can be used as a rescue device if necessary.

A reel for receiving a dimensionally stable hose, which reel has at least two flat struts running outwardly from the axis of the reel, additionally contributes to solving the problem. These struts are arranged in at least one plane perpendicular to the axis of the reel. This plane is in turn positioned along the axis of the reel such that a hose diameter fits between the plane and the adjacent end of the reel. Should a plurality of such planes be provided, they also have in each case a distance of a hose diameter to the corresponding adjacent plane. Three or four struts are preferably arranged in each plane, wherein the number of planes is dependent on the length of the reel (in hose diameters).

By means of such a reel, the hose can unroll at any time from the reel without difficulty, regardless of whether or not the hose is filled and pressurised. Pressure surges as the hose is being filled do not cause individual coils to release, unwind or jam. Rather, the hose is guided by the struts as it unwinds and always remains fully under control.

The problem is also solved by a device for the safe and organised guided handling of the hose supply in the event of a firefighting operation, said device comprising a hose and a reel. The reel has a central water connection, which is rotatable relative to the reel and ensures a fluid connection to the hose, which can be wound on the reel. The device additionally comprises a bag for transporting the hose, wherein more than 50% of the surface of the bag consists of flexible material and the bag has at least one handle and/or strap, by means of which said bag can be carried or also dragged along. The reel is rotatably mounted in the bag for unwinding of the hose.

In the event of practice or use, the bag can be brought immediately to the intended place (for example the landing next to a burning apartment) and can be connected there immediately.

Alternatively to a bag, a hard carrying case can also be used.

In the case of this device, a dimensionally stable hose is preferred. The entire system can at any time be directly filled with water and pressurised on account of the dimensionally stable hoses.

It is particularly favourable in this regard if the reel is designed as described above.

It is additionally favourable if the central water connection corresponds to a standard and the hose, at its end not connected to the central water connection, has a second connection corresponding to the same standard as the central water connection. Here, it is particularly preferred if the connections are C or D couplings, as are commonly used by fire brigades.

The inner connection of the hose with the central water connection is advantageously also standardised, preferably as a C or D coupling.

In a further embodiment, shut-off devices can be connected to or installed on the respective couplings (externally on the central water connection and/or on the end of the hose and/or on the inner end of the central water connection) and are embodied as a valve, slide, flap, or tap.

The bag can be formed and handled in a particularly simple manner if it has a hole for the central water connection.

The hose supply has an optimal length if the wound hose has a length of between 15 and 45 m, preferably between 25 and 35 m, particularly preferably 30 m.

Transport of the device is additionally facilitated if the reel consists of a lightweight metal and/or a plastic, whereby the weight thereof is minimal.

In a preferred embodiment of the device a dimensionally stable short hose is connected to the central water connection. This is between 1 and 3 m long, preferably between 1.5 and 2.5 m long, particularly preferably 2 m long, and can be used as an attack hose.

If the central water connection is fixedly connected to the bag, the reel is thus secured against falling out.

For everyday use in the fire brigade, it is additionally advantageous if at least one fastening possibility for accessories is provided on the outside of the bag. Straps with hook-and-loop fasteners are typically provided for this purpose.

A highly expedient accessory is a manifold. It is thus made possible to advance with a plurality of attack lines into the storey on which the incident is occurring. The water supply line is connected to the manifold for this purpose. The short hose, which is connected to the central water connection, is connected to one of the outlets of the manifold. Whilst the device is in use, a further line can be connected to the manifold and made ready for use, for example for a second team or the backup team.

In a particularly preferred embodiment the bag has a form adapted to the form of the reel, i.e. substantially is a flat cylinder. This facilitates the unrolling of the reel within the bag. In addition, the bag is equipped with a front side and a rear side and has a peripheral hook-and-loop or zip fastener between the front side and rear side. This fastener can be slightly opened in order to unroll the hose, or can also be fully opened in order to fold open the bag and remove or insert the reel.

The peripheral fastener between the front side and rear side of the bag can have a safe-guard against unintentional opening. This can be e.g. a carabiner hook.

There are numerous possibilities for quickly rescuing unconscious individuals from the hazard zone. Since it is not possible to quickly search areas whilst carrying any of a large number of rescue devices or aids (for example basket stretchers), these must be requested during the operation. The rescuing of individuals is thus limited in most cases to removal by hand or by means of endless slings, which requires great strength. Physical limits are quickly reached, particularly when overcoming differences in height or when rescuing casualties wearing breathing apparatuses.

The device disclosed in document JP 2013-039380 A makes it possible to use a hose carrying bag, which can be used similarly to a hose carrying basket, as a rescue device once the hoses have been removed. To this end, two such bags can be combined to form a stretcher using two accompanying rods. This approach is relatively cumbersome and absolutely necessitates a second person, and therefore the advantage compared to the requesting of an additional rescue device (of any design) seems to be relatively small in practice.

It would be much simpler if the proposed bag were used as a rescue device. The bag can be used as a rescue device if a sufficient number of carry handles and/or straps are provided so as to be able to transport an unconscious person in the folded-open bag.

It is favourable, for use of the bag as a rescue device, if the front side and/or the rear side of the bag are/is reinforced by a plate. The plate increases stability and can be used as a back support for the person to be transported. The plate is preferably a plastic plate.

If the reinforcing plate has skids and/or rollers on the side facing away from the bag, this facilitates the transporting of the bag significantly, particularly if the hose has already been filled with water.

If the reinforcing plate is removable, greater flexibility is provided in the case of use as a rescue device, in particular if the plate has fastening possibilities for a person to be rescued. Said fastening possibilities can here be constituted by a rescue sheet or rescue slings. The plate is typically fastened to the bag by large hook-and-loop fastener pads.

It is additionally advantageous if a head plate, which can be folded out, is attached to the reinforcing plate, which head plate supports and protects the head of the person to be transported. This is important particularly when the folded-open bag is to be used in the same fashion as a stretcher.

It is additionally favourable if a connecting region between the front side and the rear side of the bag is reinforced as a hinge. A bag of such design can be used in particular as a rescue nappy harness.

In order to facilitate the use of the bag as a rescue device, a hook-and-loop fastener can be provided on the side of the bag on which the central water connection of the reel is arranged, so as to enable quick opening of the bag and removal of the reel, even without having to first release the hose, which may or may not be connected.

User orientation in very poor visibility conditions (for example caused by thick smoke in closed spaces) can be facilitated in that a safety line is attached to the bag and is provided with means for automatic winding.

Further facilitation in the event of poor visibility is provided if a lighting means is provided on the front side and/or the inside of the bag. The lighting means on the inside is advantageous in particular for use of the bag as a rescue device.

The amount of force and work involved when using the proposed device is reduced if the bag is provided with means for automatically winding the reel.

Further details and features will emerge from the following description of preferred exemplary embodiments in conjunction with the dependent claims. Here, the respective features can be implemented individually or in combination with one another. The possibilities for solving the problem are not limited to the exemplary embodiments. For example, specified ranges thus always comprise all intermediate values (not stated) and all conceivable sub-ranges.

The exemplary embodiments are shown schematically in the figures. Like reference signs in the individual figures denote like or functionally like elements or elements that correspond to one another in respect of their function. Individually:

FIG. 1 shows a reel, as is used in the present invention, in a side view.

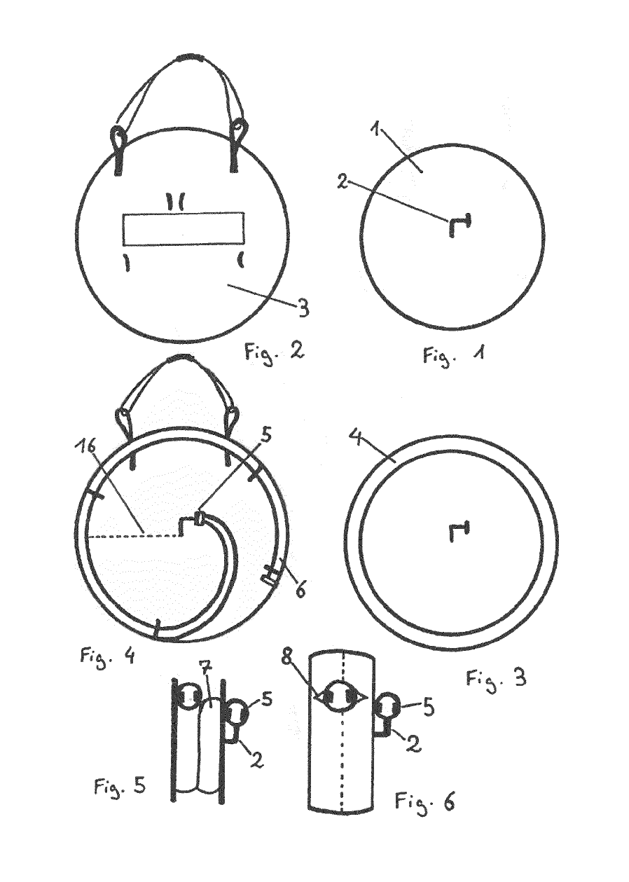

FIG. 2 shows the rear side of a device according to the invention with various fastening possibilities for accessories;

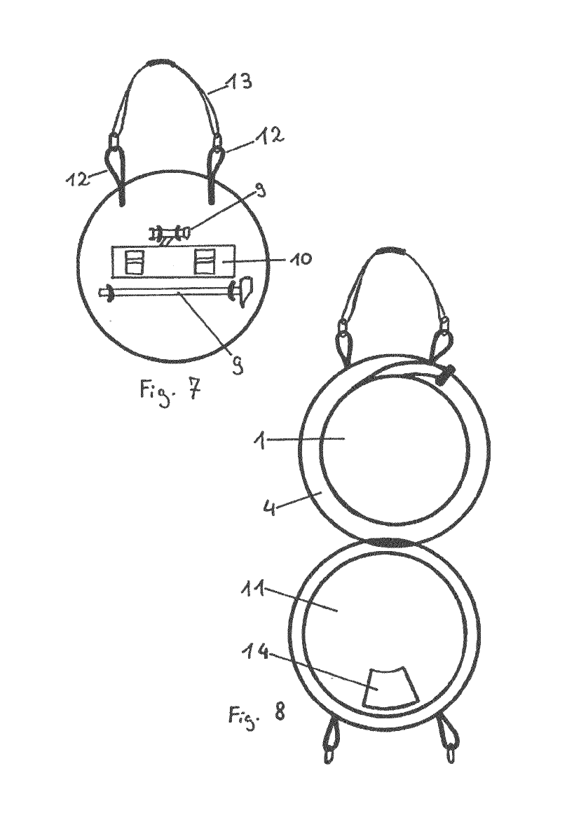

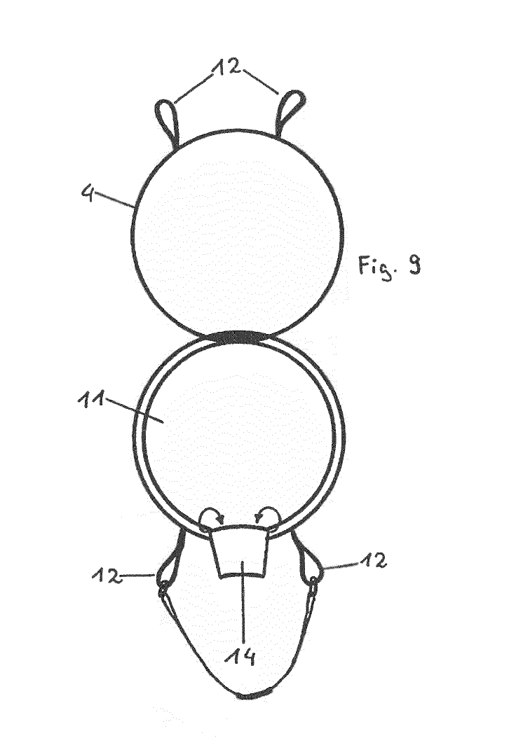

FIG. 3 shows the reel from FIG. 1 in a bag according to the invention;

FIG. 4 shows the front side of a device according to the invention with a short hose;

FIG. 5 shows an end-face view of the reel with wound hose;

FIG. 6 shows an end-face view of the bag, slightly opened in order to unroll the hose;

FIG. 7 shows the rear side of the bag with common firefighting accessories;

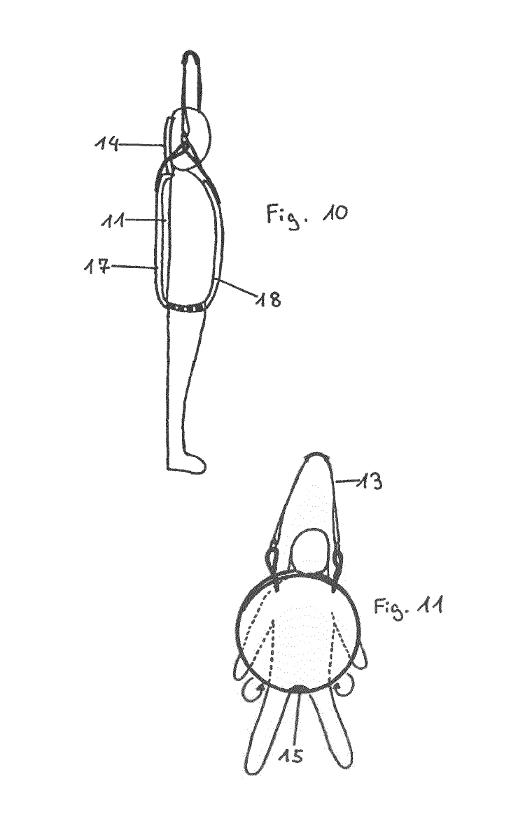

FIG. 8 shows the bag in the folded-open state with reel and reinforcement plates;

FIG. 9 shows the folded-open bag without reel with folded-out head plate;

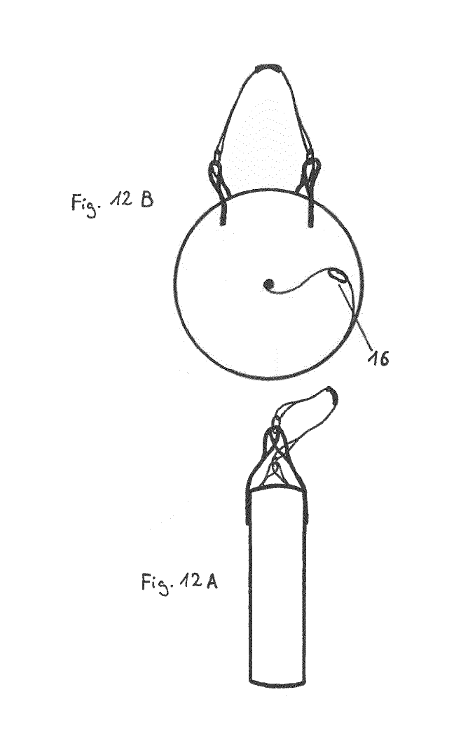

FIG. 10 shows the use of the bag as a basket stretcher or rescue nappy harness;

FIG. 11 shows the use of the bag as a basket stretcher or rescue nappy harness, wherein the hinge is reinforced;

FIG. 12A shows the end face of a bag according to the invention with quick-action fastener;

FIG. 12B shows the front side of a bag according to the invention with quick-action fastener;

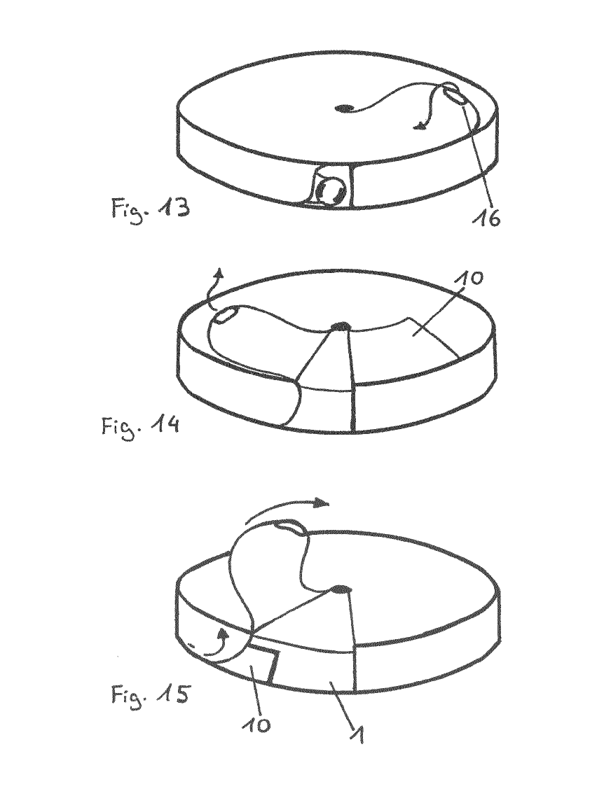

FIG. 13 shows the start of opening of the quick-action fastener;

FIG. 14 shows further opening of the bag by means of the quick-action fastener;

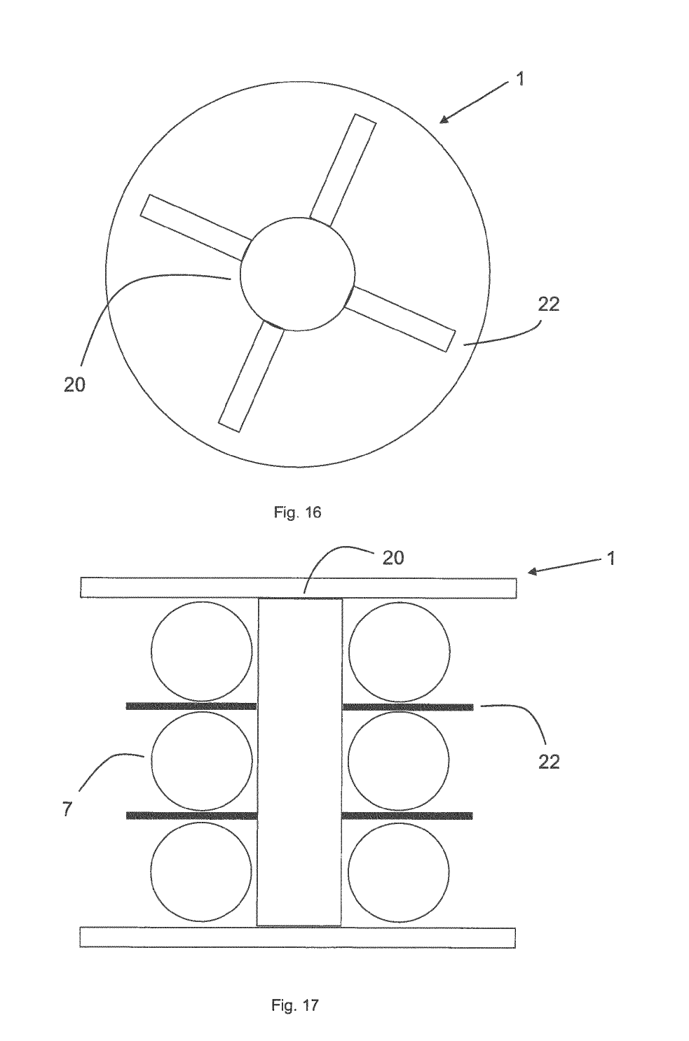

FIG. 15 shows a third step during opening of the bag by means of the quick-action fastener;

FIG. 16 shows a schematic section through a plane of a reel for a dimensionally stable hose according to the invention; and

FIG. 17 shows a schematic longitudinal sectional view through such a reel.

The following relates to FIGS. 1 to 6. In the case of the proposed invention a hose reel 1 with central water connection 2 is combined with a matching carry bag 3. The hose reel 1 hereby lies in the inside 4 of the bag and is mounted on a bearing device which is combined with the central water connection 2. The water connection pipe runs outwards through an opening in the bag. At its end, a dimensionally stable short hose 6 can be attached, which can be fixed externally to the bag for transport. This short hose can be used as an attack hose. At the end of the short hose there is typically attached a C or D coupling 5, as is commonly used by the fire brigade. A hose 7, which likewise is dimensionally stable, is connected to and wound on the hose reel 1 arranged in the bag 3. The inner hose 7 is 15 to 35 metres long, depending on the embodiment. The hose end is fixed at an opening 8 on the end face of the bag. The dimensionally stable hose can thus be easily released and removed from the hose reel.

The bag is made of a very robust and tear-resistant material. As shown in FIG. 7, various aids 9 can be fastened on the front side of the surface (e.g. fog nozzle, firefighter's axe, mobile smoke screen, manifold, etc.), and various sets, holsters and/or pockets can be fastened to a hook-and-loop fastener pad 10. Two hand loops 12, which can be connected to a carabiner, are fastened in each case on the front side and rear side. The carabiners can be connected individually to an endless sling 13—depending on whether the bag is to be carried, dragged, hung or used as a rescue device.

It can be seen in FIG. 8 that a plastic plate 11 is attached to the rear side of the bag 3. This can form the outside of the bag 3. However, it can also be fastened on the inside 4 of the bag 3. It is also possible that the plastic plate 11 is sewn in at the rear side of the bag 3 between two material layers.

The plastic plate 11 ensures greater stability, but serves primarily as a back support for individuals lying on it, and potentially reduces the coefficient of adhesion or sliding friction as the bag is dragged along, and as applicable acts simultaneously as protection against wear.

Due to the specific arrangement of the hand loops 12 on the bag, individuals to be rescued can be quickly and easily fixed for transport. In order to perform the transport, it is expedient however to firstly remove the hose reel from the bag. An additional plastic plate 14 is then folded out to support the head. This can be seen in FIG. 9. Here, the bag is completely folded open. Once the individual has been positioned on the folded-open bag 4, this bag can be used as a stretcher. By means of the folded-out head support 14, comfortable positioning is made possible. The hand loops 12 are used as carry handles.

An alternative variant of the use of the bag as rescue device is shown in FIGS. 10 and 11: The person is positioned on the upper part 17 (with the reinforcement plate 11) of the folded-open bag. The head part 14 is likewise folded out. The lower part 18 of the bag is then guided up between the legs of the person to be rescued and placed over the legs (sandwich technique). The hand loops from the front and rear side are brought together and are connected by the carabiners. The endless sling 13, which is likewise connected to the carabiners, is used here as a pulling rope in order to pull the resultant basket stretcher from the hazard zone. For this application, the hinge region 15 of the bag is additionally reinforced.

For improved transportation of individuals, the hose reel can be easily removed from the bag. This is shown in FIGS. 12 to 15. A special quick-action fastener opening 16 with hook-and-loop fastener pads, by means of which the bag can also be opened on the side next to the connection pipe, makes it possible to remove the hose reel within a few seconds, without even disconnecting the hose line. FIGS. 12A and B show the closed bag from the outside.

In FIG. 13 the overlapping part of the upper side is being released from the hook-and-loop fastener pad 10. Further opening can be seen in FIG. 14—the hook-and-loop fastener pad 10 is already exposed here. In FIG. 15 the opening process has progressed further; the bag is also open at the end face, such that the reel 1 can be removed.

An improved reel for a dimensionally stable hose can be seen in FIGS. 16 and 17. FIG. 16 shows how the preferably four struts 22 are arranged in the plane of section, specifically with equal angular distance around the central axis 20 of the reel 1. The struts organise and control the course of the coils of a dimensionally stable hose wound onto the reel. This is shown in longitudinal section through the reel 1 in FIG. 17. The struts 22 are arranged in planes that are positioned at the central axis 20 of the reel at distances corresponding to the diameter of the dimensionally stable hose 7. The hose can be wound similarly to thread on a thread spool, since it is possible to change without difficulty from one coil plane to the next in the gaps between the struts.

### GLOSSARY

### Attack Hose

This term denotes the hose or hose portion to which the jet nozzle is connected and from which the extinguishing agent exits during the firefighting operation.

### Reel

A reel is a technical aid for winding and unwinding elongate materials, such as threads, ropes, wires and tapes—in this case hoses, for which reason reference is also made to a hose reel. It has a bobbin-like structure, which is mounted rotatably about a central axis, as is the case in a cable drum for electrical cables.

### Hose Supply

This term denotes a hose length (typically 15-30 m), which is additionally provided at a suitable distance from the source of fire so as to be able to advance towards the source of fire with the attack hose (see above) without great resistance.

### Bag

A bag is a container for transporting objects. A bag is made primarily of flexible material and has at least one handle, loop or strap, by which the bag can be carried.

### REFERENCE NUMERALS

1 reel
2 central water connection
3 bag
4 inside of the bag
5 hose coupling
6 dimensionally stable short hose
7 dimensionally stable hose
8 opening in the end face of the bag
9 accessories
10 hook-and-loop fastener pad
11 plastic plate
12 hand loops
13 endless sling
14 head plate
15 reinforced region
16 opening for quick removal
17 underside of the basket stretcher or rescue nappy harness
18 top side of the basket stretcher or rescue nappy harness
20 central axis of the reel
22 strut

### CITED LITERATURE

### Cited Patent Literature

AT 36548
DE 867 954
U.S. Pat. No. 3,722,823
JP 2013-039380 A

1. A method for handling a hose supply when extinguishing a fire, said method comprising the following steps:
1.1 a water supply line is laid with the aid of at least one hose or is provided by a fire engine;
1.2 a hose (7) is provided;
1.3 a reel (1) is provided;
1.3.1 wherein the reel (1) has a central water connection (2);
1.3.2 wherein the central water connection (2) is rotatable relative to the reel (1);
1.3.3 wherein the hose (7) is wound on the reel (1);
1.3.4 wherein the central water connection (2) ensures a fluid connection to the hose (7);
1.4 wherein the hose (7) is formed in such a way that it has a second connection at its end not connected to the central water connection (2);
1.5 a transport device (3) for the reel is provided;
1.5.1 wherein the reel (1) is mounted rotatably in the transport device (3) for unwinding of the hose (7);
1.6 the transport device (3) is fixed in the area of the end of the water supply line;
1.7 the water supply line is connected to the central water connection (2) of the reel (1); and
1.8 the hose (7) is unwound from the reel only by the length required to reach the fire;
1.8.1 whereby the hose (7) is used as an attack hose to extinguish the fire.

2. A method for handling a hose supply when extinguishing a fire, said method comprising the following steps:
2.1 a water supply line is laid with the aid of at least one hose or is provided by a fire engine;
2.2a hose (7) is provided;
2.3 a reel (1) is provided;
2.3.1 wherein the reel (1) has a central water connection (2);
2.3.2 wherein the central water connection (2) is rotatable relative to the reel (1);
2.3.3 wherein the hose (7) is wound on the reel (1);
2.3.4 wherein the central water connection (2) ensures a fluid connection to the hose (7);
2.4 wherein the hose (7) is formed in such a way that it has a second connection at its end not connected to the central water connection (2);
2.5 a transport device (3) for the reel is provided;
2.5.1 wherein the reel (1) is mounted rotatably in the transport device (3) for unwinding of the hose (7);
2.6 the water supply line is connected to the second connection of the hose (7);
2.7 an attack hose is connected to the central water connection (2) of the reel (1); and
2.8 the attack hose is guided to the fire;
2.8.1 wherein the transport device (3) is brought along with the reel (1) with the hose (7);
2.8.2 wherein the hose (7) is unwound from the reel (1) only by the length required to reach the fire.

3. The method according to either one of the preceding claims,
characterised in that
3.1 a dimensionally stable hose (7) is provided; and
3.2 a bag (3) is provided as transport device;
3.2.1 wherein the bag (3) has a form adapted to the form of the reel (1);
3.2.2 wherein more than 50% of the surface of the bag consists of flexible material; and
3.2.3 wherein the bag has at least one handle and/or strap (12, 13), by which it can be carried.

4. A method for handling a hose supply when extinguishing a fire, said method comprising the following steps:
4.1 a water supply line is laid with the aid of at least one hose or is provided by a fire engine;
4.2 a hose (7) is provided;
4.3 a reel (1) is provided;
4.3.1 wherein the reel (1) has a central water connection (2);
4.3.2 wherein the central water connection (2) is rotatable relative to the reel (1);
4.3.3 wherein the hose (7) is wound on the reel (1);
4.3.4 wherein the central water connection (2) ensures a fluid connection to the hose (7);
4.4 a bag (3) is provided for transporting the reel;
4.4.1 wherein more than 50% of the surface of the bag consists of flexible material;
4.4.2 wherein the bag (3) has at least one handle and/or strap (12, 13), by which it can be carried; and
4.4.3 wherein the reel (1) is mounted rotatably in the bag (3) for unwinding of the hose (7);
4.5 the hose (7) is connected to the water supply line; and
4.6 the hose (7) is unwound from the reel only by the length required to reach the fire.

5. A reel for receiving a dimensionally stable hose (7);
characterised by
5.1 at least two flat struts (22), which run outwards from the axis (20) of the reel (1);
5.2 wherein the struts (22) are arranged in at least one plane perpendicular to the axis (20) of the reel (1);
5.3 wherein the at least one plane is arranged along the axis (20) of the reel (1) in such a way that a hose diameter (7) fits between the plane and the adjacent end of the reel;
5.4 and wherein, if more than one such plane is provided, the planes in each case maintain a distance of a hose diameter (7) from the corresponding adjacent plane.

6. A device for carrying out the method according to any one of the method claims.

7. A device for the safe and organised guided handling of the hose supply in the event of a fire-fighting operation, comprising:
7.1 a hose (7);
7.2 a reel (1);
7.2.1 wherein the reel (1) has a central water connection (2);
7.2.2 wherein the central water connection (2) is rotatable relative to the reel (1);
7.2.3 wherein the hose (7) can be wound on the reel (1);
7.2.4 wherein the central water connection (2) can ensure a fluid connection to the hose (7);
7.3 a bag (3) for transporting the reel;
7.3.1 wherein more than 50% of the surface of the bag consists of flexible material;
7.3.2 wherein the bag (3) has at least one handle and/or strap (12, 13), by which it can be carried; and
7.3.3 wherein the reel (1) is mounted rotatably in the bag (3) for unwinding of the hose (7);

8. The device according to the preceding claim,
characterised in that
the device has a hard carrying case instead of the bag (3) for transporting the reel (1).

9. The device according to any one of the preceding device claims,
characterised in that
the hose (7) is dimensionally stable

10. The device according to the preceding claim,
characterised in that
the reel (1) is formed in accordance with claim 5.

11. The device according to any one of the preceding device claims,
characterised in that
11.1 the central water connection (2) corresponds to a standard; and
11.2.1 the hose (7) has a second connection at its end not connected to the central water connection (2);
11.2.2 wherein the second connection corresponds to the same standard.

12. The device according to any one of the preceding device claims,
characterised in that
the central water connection (2) and/or an end of the hose (7) has a shut-off device.

13. The device according to any one of the preceding device claims,
characterised in that
the bag (3) has a hole for the central water connection (2).

14. The device according to any one of the preceding device claims,
characterised in that
the wound hose (7) has a length of between 15 and 45 m, preferably between 25 and 35 m.

15. The device according to any one of the preceding device claims,
characterised in that
the reel (1) consists of a lightweight metal and/or a plastic.

16. The device according to any one of the preceding device claims,
characterised in that
a dimensionally stable short hose (6) is connected to the central water connection (2).

17. The device according to any one of the preceding device claims,
characterised in that
the central water connection (2) is fixedly connected to the bag (3).

18. The device according to any one of the preceding device claims,
characterised in that
at least one fastening possibility (10) for accessories (9) is provided on the outside of the bag (3).

19. The device according to any one of the preceding device claims,
characterised in that
19.1 the bag (3) has a form adapted to the form of the reel (1);
19.2 the bag (3) has a front side and a rear side; and
19.3 the bag has a peripheral hook-and-loop or zip fastener between the front side and rear side.

20. The device according to the preceding claim,
characterised in that
the peripheral fastener between the front side and rear side of the bag (3) has a safeguard against unintentional opening.

21. The device according to claim 19 or 20,
characterised in that
a sufficient number of carry handles and/or straps (12, 13) are provided in order to be able to transport an unconscious person in the folded-open bag.

22. The device according to any one of the preceding device claims,
characterised in that
the front and/or the rear side of the bag (3) is reinforced with a plate (11).

23. The device according to the preceding device claim,
characterised in that
the reinforcing plate (11) has skids and/or rollers on the side facing away from the bag.

24. The device according to either one of the two preceding device claims,
characterised in that
the reinforcing plate (11) is removable.

25. The device according to the preceding device claim,
characterised in that
the reinforcing plate (11) has fastening possibilities for a person to be rescued.

26. The device according to any one of claims 22 to 25,
characterised in that
a head plate (14), which can be folded out, is attached to the reinforcing plate (11).

27. The device according to any one of the preceding device claims,
characterised in that
a connection region (15) between the front side and the rear side of the bag (3) is reinforced as a hinge.

28. The device according to any one of the preceding device claims,
characterised in that
a hook-and-loop fastener (16) is provided on the side of the bag (3) on which the central water connection (2) of the reel (1) is arranged so as to enable quick opening of the bag (3) and removal of the reel (1).

29. The device according to any one of the preceding device claims,
characterised in that
29.1 a safety line is attached to the bag (3);
29.2 wherein the safety line is provided with means for automatic winding.

30. The device according to any one of the preceding device claims,
characterised in that
a lighting means is provided on the end face and/or the inside (4) of the bag (3).

31. The device according to any one of the preceding device claims,
characterised in that
the bag (3) is provided with means for automatically winding the reel (1).

32. Use of a device comprising
32.1 a hose (7);
32.2 a reel (1);
32.2.1 wherein the reel (1) has a central water connection (2);
32.2.2 wherein the central water connection (2) is rotatable relative to the reel (1);
32.2.3 wherein the hose (7) can be wound on the reel (1);
32.2.4 wherein the central water connection (2) ensures a fluid connection to the hose (7);
32.3 wherein the hose (7) has a second connection at its end not connected to the central water connection (2); and
32.4 a transport device (3) for transporting the reel (1);
32.4.1 wherein the reel (1) is mounted rotatably in the transport device for unwinding of the hose (7);
for carrying out the method according to any one of the method claims.

33. Use of a device comprising
33.1 a dimensionally stable hose (7);
33.2 a reel (1);
33.2.1 wherein the reel (1) has a central water connection (2);
33.2.2 wherein the central water connection (2) is rotatable relative to the reel (1);
33.2.3 wherein the dimensionally stable hose (7) can be wound on the reel (1);
33.2.4 wherein the central water connection (2) ensures a fluid connection to the dimensionally stable hose (7);
33.3 wherein the dimensionally stable hose (7) has a second connection at its end not connected to the central water connection (2); and
33.4 a frame with wheels for transporting the reel (1);
33.4.1 wherein the reel (1) is mounted rotatably in the frame for unwinding of the hose (7);
for carrying out the method according to any one of the method claims.

34. Use of a device comprising a reel according to claim 5 for carrying out the method according to any one of the method claims.

35. Use of a device according to any one of the device claims for carrying out the method according to any one of the method claims.

36. Use of the bag (3) from a device according to any one of the device claims as a rescue device.
